(19) United States
(12) Patent Application Publication
(10) Pub. No.: US 2009/0144299 A1
(43) Pub. Date: Jun. 4, 2009

(54) Data storage method

(76) Inventors: Ann Helena Ledwith, Manchester (GB); Neil Simon French, Liverpool (GB); Peter James Cridland, Worsley (GB); Sharon O'kane, High Peak (GB); Mark William James Ferguson, High Peak (GB)

Correspondence Address: MORRISON & FOERSTER LLP, 755 PAGE MILL RD, PALO ALTO, CA, 94304-1018, US

(21) Appl. No.: 11/989,035

(22) PCT Filed: Jun. 28, 2006
(86) PCT No.: PCT/GB2006/002387

§ 371 Date: Jan. 18, 2008

Related U.S. Application Data
(60) Provisional application No. 60/700,958, filed on Jul. 20, 2005.

(30) Foreign Application Priority Data
Jul. 20, 2005 (GB) 0514830.9

(51) Int. Cl. G06F 17/30

(52) U.S. Cl. 707/100; 707/E17.044; 707/E17.01

(57) ABSTRACT

A method for storing data in a database. The method uses configuration data defining an entity and a condition associated with the entity. The method comprises processing a plurality of data items, said processing including determining for each data item whether said condition is satisfied by one of said plurality of data items. If said condition is satisfied by one of said plurality of data items, creating an instance of said entity, said entity being associated with said one data item.

The present invention relates to a method of storing data in a database.

It is well known to store data in a database. A database management system is typically used to allow a user to enter data to the database, and access data stored in the database. Databases store data items in a well defined manner and typically provide functionality to ensure that data integrity is maintained, and in some cases to ensure that access by a plurality of users is correctly handled.

Many databases are of a type known as relational databases. In such databases data is stored within a plurality of database tables. Each table specifies a plurality of fields, and each field is arranged to store a particular type of data. A plurality of records are stored in each database table, and each record has values stored in the respective fields. Relationships between tables of the database are specified, and these relationships define relations between data items stored in the respective tables. Similarly, relationships involving only a single table of the database can be specified. Relational Databases are typically defined in a database definition language such as the Structured Query Language (SQL) which allows database tables to be created, relationships to be specified, and queries to be executed which retrieve data from the database tables.

Use of a database definition language to perform all data manipulation operations is undesirable given that only skilled users with knowledge of the syntax and functionality of the database definition language can use the database. In order to overcome this problem, some databases are provided with a Graphical User Interface (GUI) which allows a relatively unskilled user to access and edit data within the database by using an interface which is easy and intuitive to use.

It will be appreciated that it is a time consuming task to enter a large quantity of data into a database. Although a GUI may allow data entry to be carried out by relatively unskilled operators, the task is still time consuming.

As indicated above, data of a variety of different types can be stored within a database. Some databases are arranged to store images. Typically digital images are stored as image files on a computer system, and a database management system is used to allow suitable cataloguing and querying of images, and storage of metadata which may be associated with the images.

It will be appreciated that in the case of image databases, entering details of image files into the database (e.g. by use of a GUI) is time consuming. Similarly the manual creation of metadata relating to the images is a similarly labour intensive process.

It is an object of the present invention to obviate or mitigate at least some of the problems outlined above.

According to the present invention, there is provided, a method and apparatus for storing data in a database using configuration data The configuration data specifies an entity and a condition associated with the at least entity. The method comprises processing a plurality of data items, said processing including determining for each data item whether said condition is satisfied by one of said plurality of data items, and if said condition is satisfied by one of said plurality of data items, creating an instance of said entity, said entity being associated with said one data item.

The present invention therefore provides a method for automatically adding data items to appropriate entities within a database by processing configuration data. This obviates the need for manual entry of such data items.

The configuration data may define a plurality of entities, and each of said plurality of entities may have an associated condition. The processing may comprise determining for each data item whether a condition associated with one of said plurality of entities is satisfied by the respective data item. If one of said conditions is satisfied, an instance of the entity associated with the satisfied condition is created, said entity being associated with the respective data item.

The processing may comprise processing a plurality of items arranged within a predetermined location in a data repository, and each of said data items may have an associated identifier. The condition associated with the or each entity may comprise a text string, and the condition may be satisfied by a data item having an identifier having a predetermined relationship with said text string. For example, the predetermined relationship may be defined to be a predetermined degree of matching between the identifier and the text string. The text string may include at least one wildcard character. The wildcard character may be configured to match any character of said identifier or alternatively to match any zero or more characters of said identifier.

In some embodiments of the invention the data item is stored within said created entity, while in other embodiments, a reference to said data item is stored within the created entity.

The plurality of data items may be a plurality of files, and the plurality of files may be stored within a predetermined directory of a file system. The predetermined directory may comprise at least one sub-directory, and said sub-directory contains at least some of said plurality of files.

The method may comprise processing items stored in the predetermined directory, and for each processed item, determining whether said item is a sub-directory or a file. The condition may be based upon said determination.

The method may comprise processing said plurality of files and determining a file type associated with each of said plurality of files. The condition may specify a predetermined file type.

The method may comprise generating metadata associated with said one data item, and storing said metadata within said instance of said entity. Generating the metadata may comprise generating said metadata based upon said one data item and/or based upon a name and/or type of said file.

The configuration data may define at least one relationship involving the or each entity. The relationship may define a hierarchy of entities. Creating an instance of an entity may comprise determining existence of an appropriate instance of an entity at a higher hierarchical level and creating said instance of an entity at a higher hierarchical level if said determining determines that said no instance of said entity exists.

According to a second aspect of the present invention, there is provided a method and apparatus for storing data in a database. The method comprises determining an entity to be instantiated to store said data, processing data defining at least one relationship between said entity and at least one further entity, determining existence of an appropriate instance of said at least one further entity, and creating said instance of said at least one further entity if said determining determines that said no appropriate instance of said at least one entity exists.

Determining an entity to be instantiated may comprise processing configuration data defining a plurality of entities and a condition associated with each entity, processing a data item, said processing including determining if a condition satisfied by said data item, and creating an instance of the entity associated with said satisfied condition.

According to a third aspect of the present invention, there is provided a method for storing data in a database using configuration data defining a plurality of entities and conditions associated with each of entities, the method comprising:

processing a data item, said processing including determining for said data item whether one of said conditions is satisfied; and,

if said condition is satisfied, creating an instance of the respective entity, said entity being associated with said one data item, processing data defining at least one relationship between said created entity and at least one further entity, determining existence of an appropriate instance of said at least one further entity, and creating said instance of said at least one further entity if said determining determines that said no appropriate instance of said at least one entity exists.

The invention further provides a computer readable medium carrying computer readable program code configured to cause a computer to carry out a method as set out above.

There is also provided a computer apparatus for storing data in a database. The computer apparatus comprises a program memory containing processor readable instructions and a processor configured to read and execute instructions stored in said program memory. The processor readable instructions comprise instructions configured to control the processor to carry out a method as set out above.

It should be noted that the various aspects of the invention can be implemented in a number of different ways including as a method, apparatus, system, and computer program. The computer program can be stored on any suitable carrier medium including a disk.

An embodiment of the present invention will now be described, by way of example, with reference to the accompanying drawings, in which:

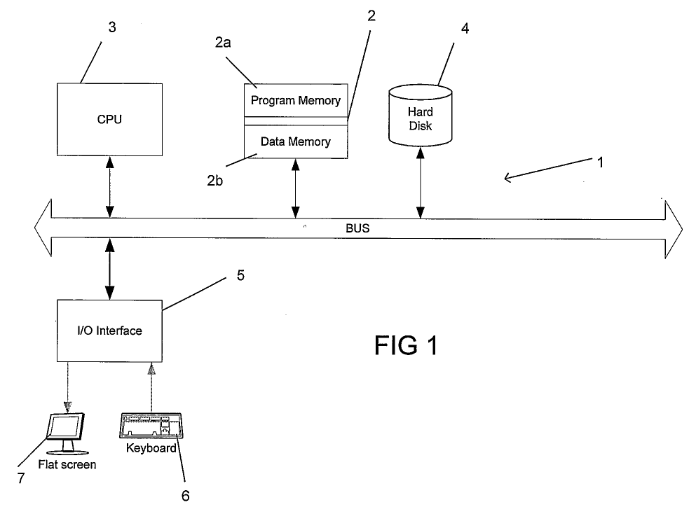

FIG. 1 is a schematic illustration of a computer system used to implement an embodiment of the present invention.

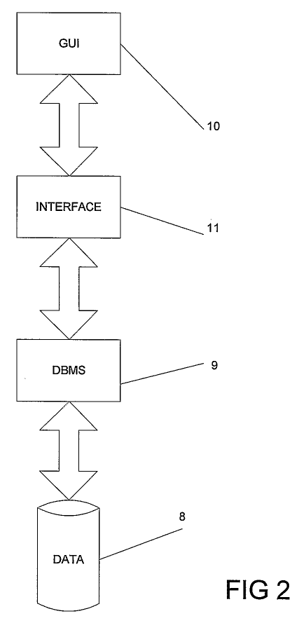

FIG. 2 is a schematic illustration of an embodiment of the present invention;

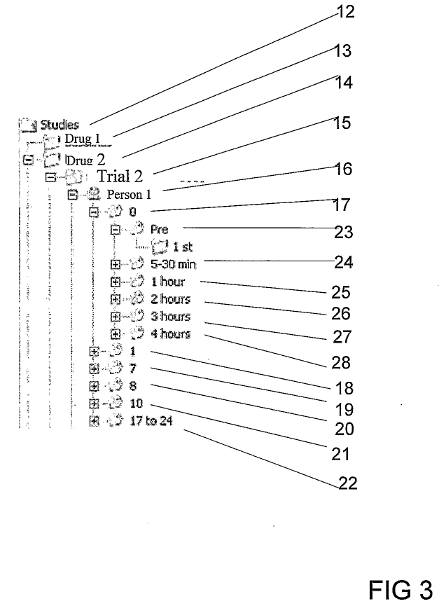

FIG. 3 is a schematic illustration of entities as represented by the database of FIG. 2;

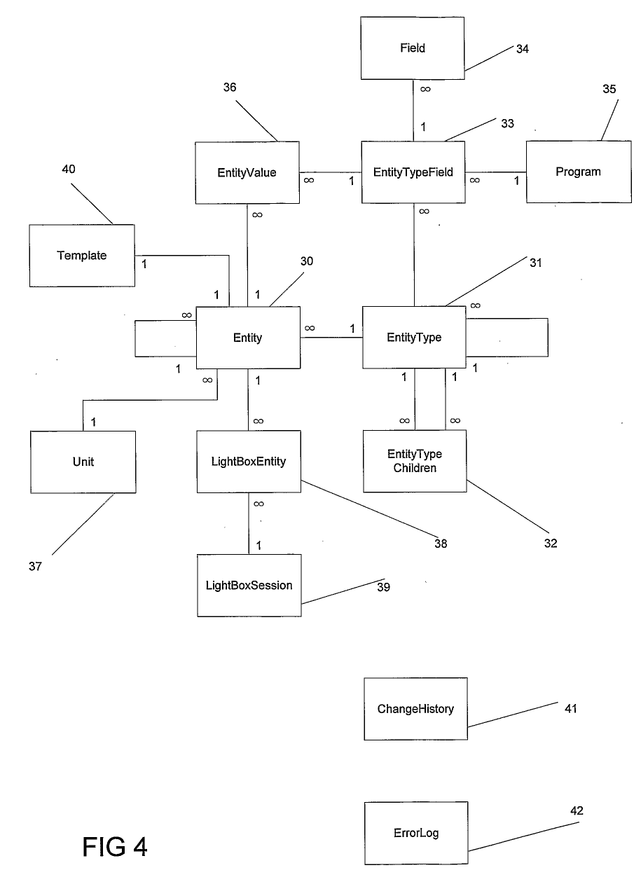

FIG. 4 is an entity relationship diagram of a database used in an embodiment of the present invention;

FIGS. 5 to 15 are schematic illustrations of tables shown in the diagram of FIG. 4;

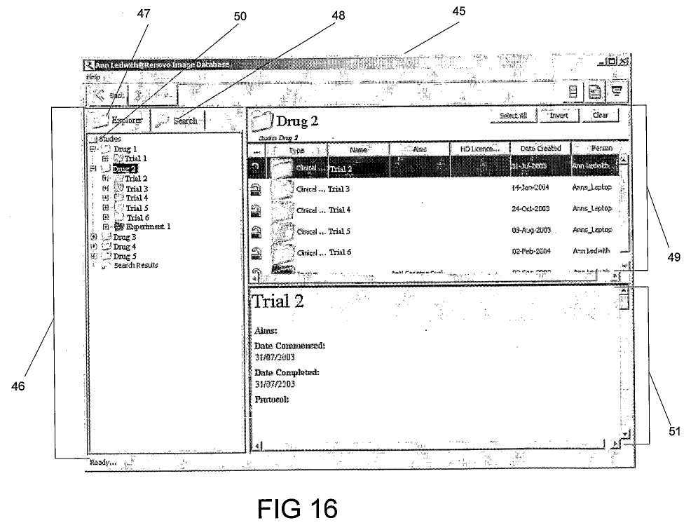

FIG. 16 is a screenshot of GUI used to access data stored in the database of FIG. 4;

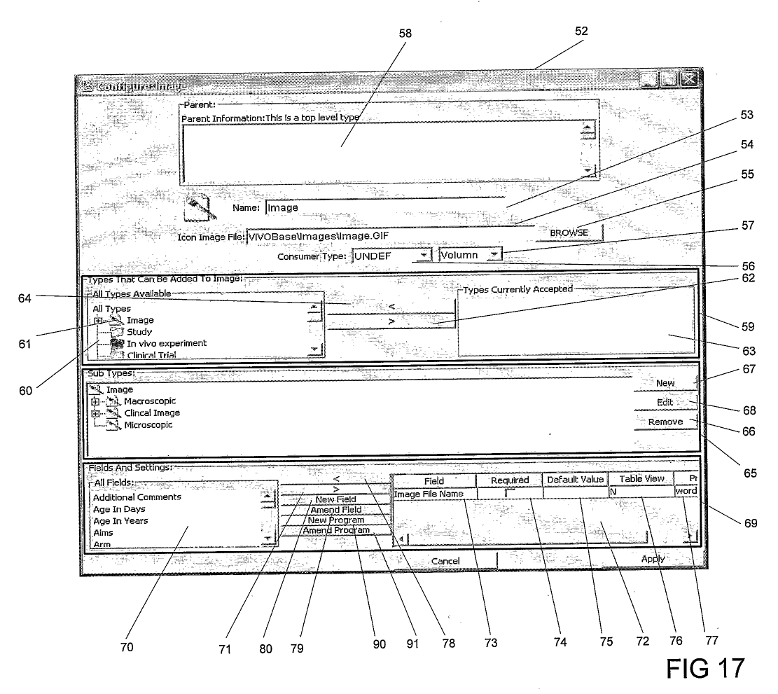

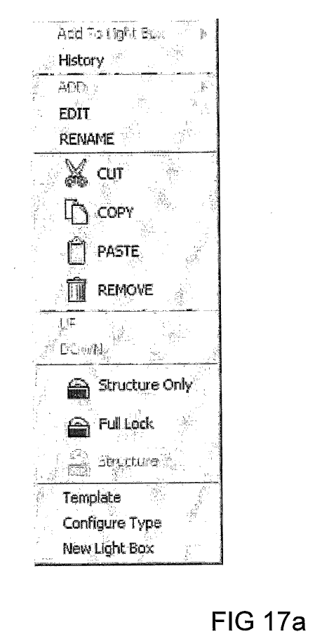

FIG. 17 is a screenshot of a GUI used to view entities and related data stored in the database of FIG. 4;

FIG. 17a is a screenshot of a menu provide by the GUI shown in FIG. 17;

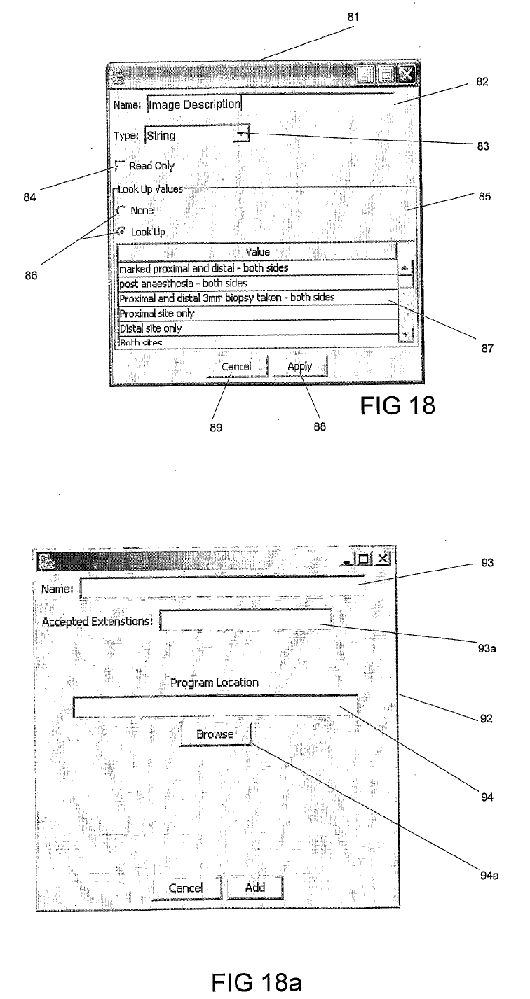

FIG. 18 is a screenshot of a GUI used to configure entities shown in the GUI of FIG. 17;

FIG. 18a is a screenshot of a GUI used to specify features of a program;

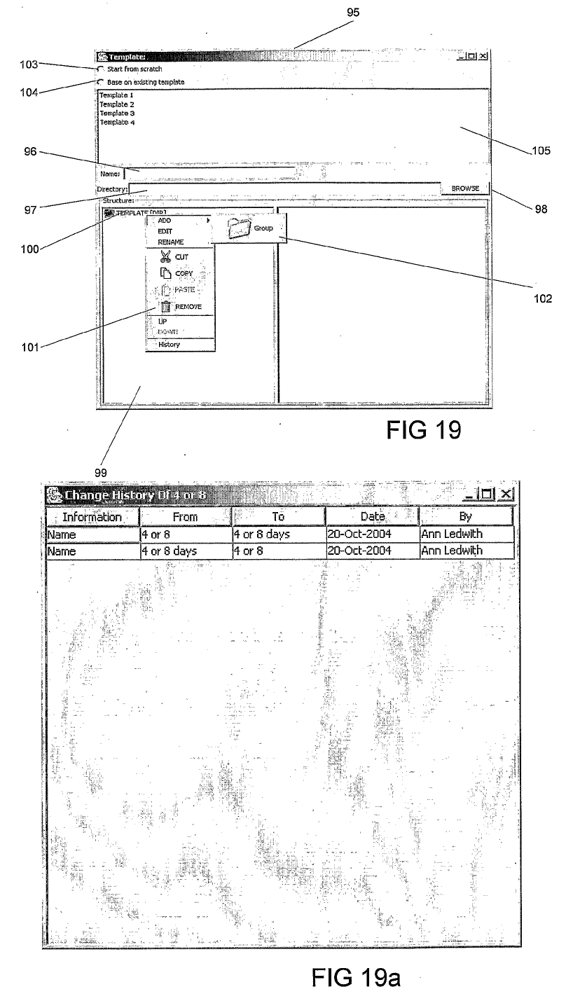

FIG. 19 is a screenshot of a GUI used to define templates used to store data into the database of FIG. 4;

FIG. 19a is a screenshot of a GUI showing an audit trial;

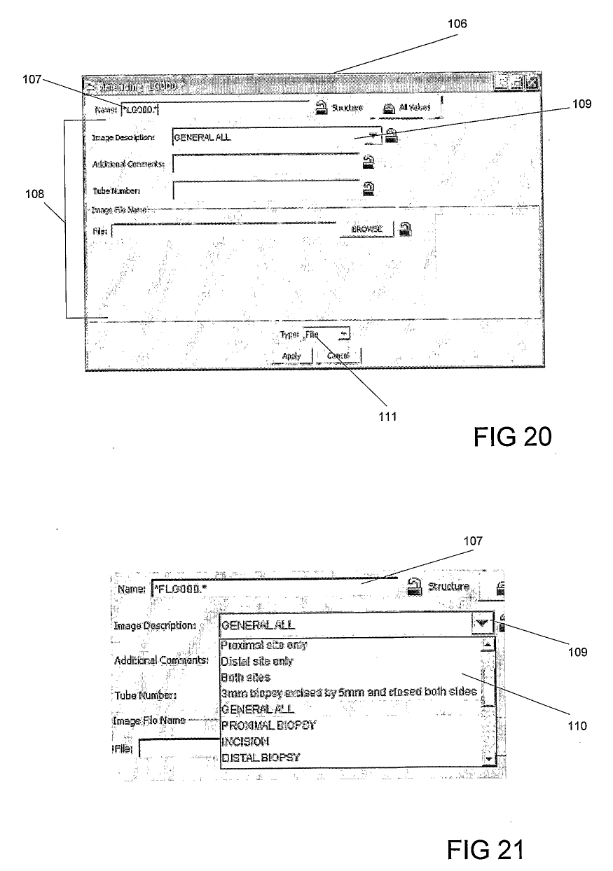

FIG. 20 is a screenshot of a GUI used to configure template entities within templates defined using the GUI of FIG. 19;

FIG. 21 is a more detailed view of part of the GUI of FIG. 20;

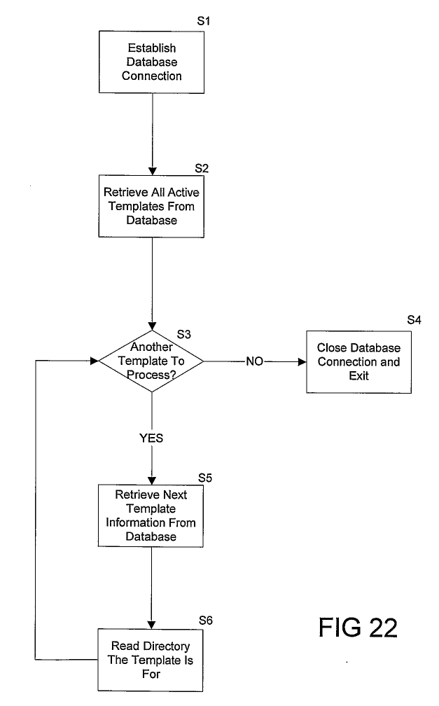

FIG. 22 is a flowchart of a method used to add image files to a hierarchy of entities;

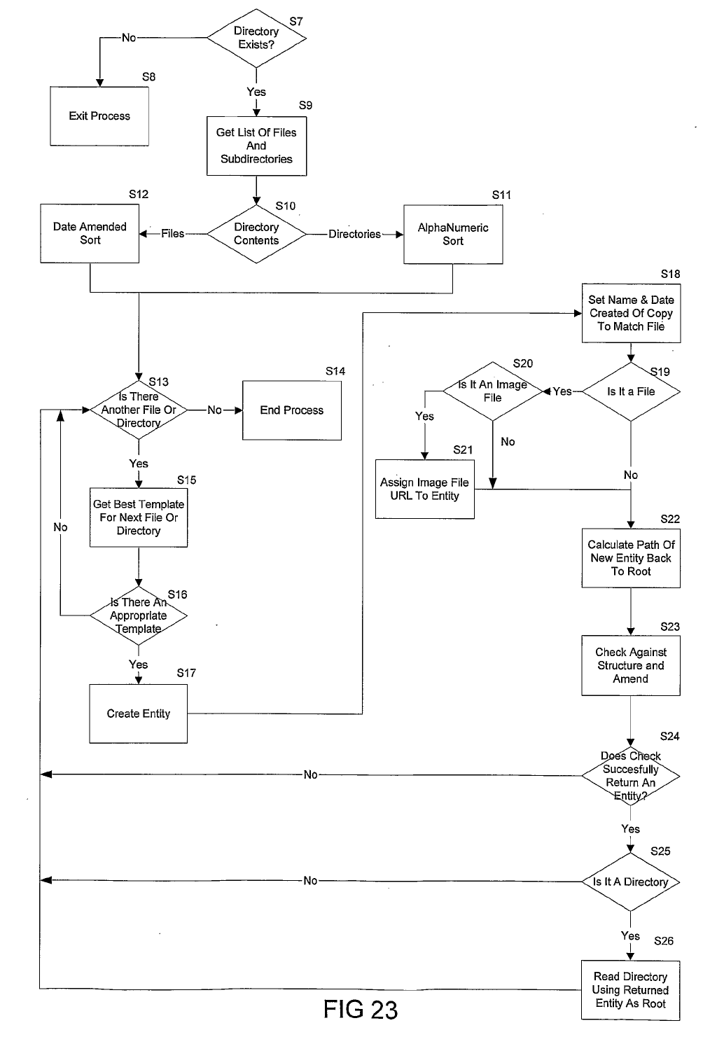

FIG. 23 is a flowchart showing part of the method of FIG. 22 in further detail;

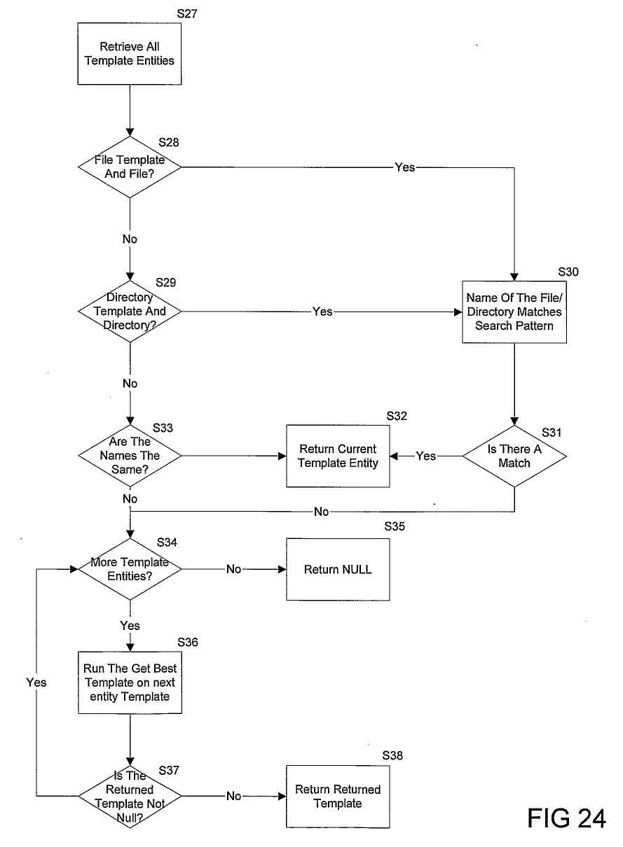

FIG. 24 is a flowchart showing part of the method of FIG. 23 in further detail;

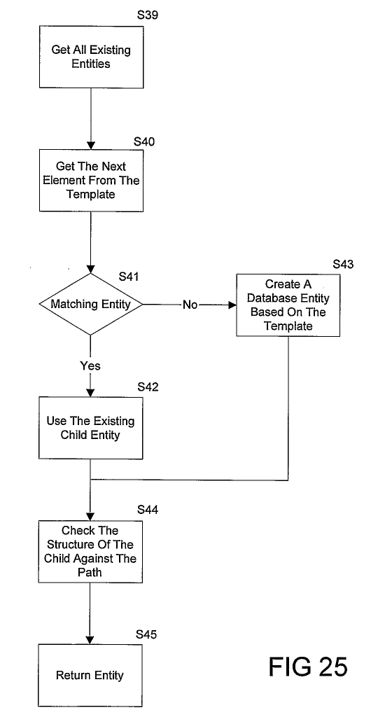

FIG. 25 is a flowchart showing part of the method of FIG. 23 in further detail;

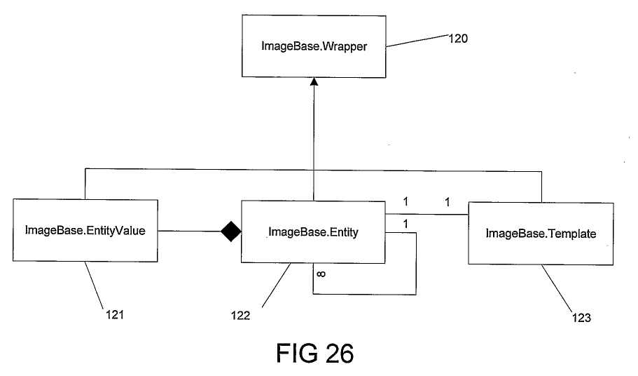

FIG. 26 is a class diagram of Java classes used in an implementation of the present invention;

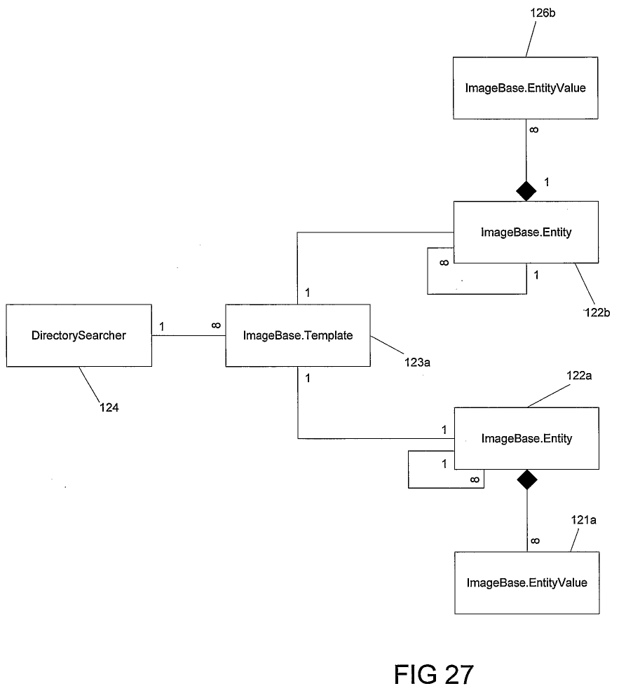

FIG. 27 is a class diagram showing relationships between classes used an embodiment of the present invention;

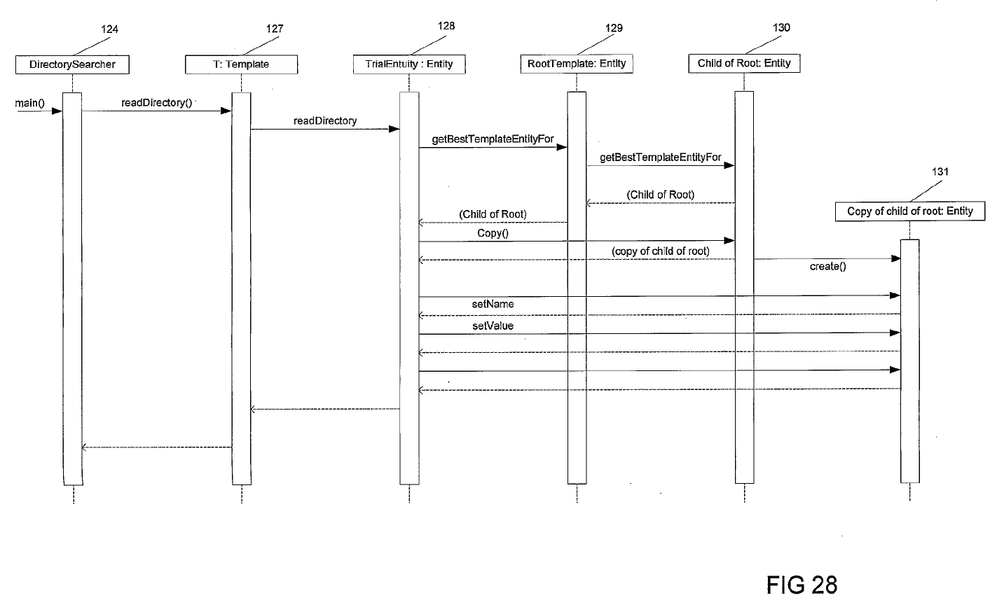

FIG. 28 is a sequence diagram showing how the classes of FIG. 27 interact to implement the present invention;

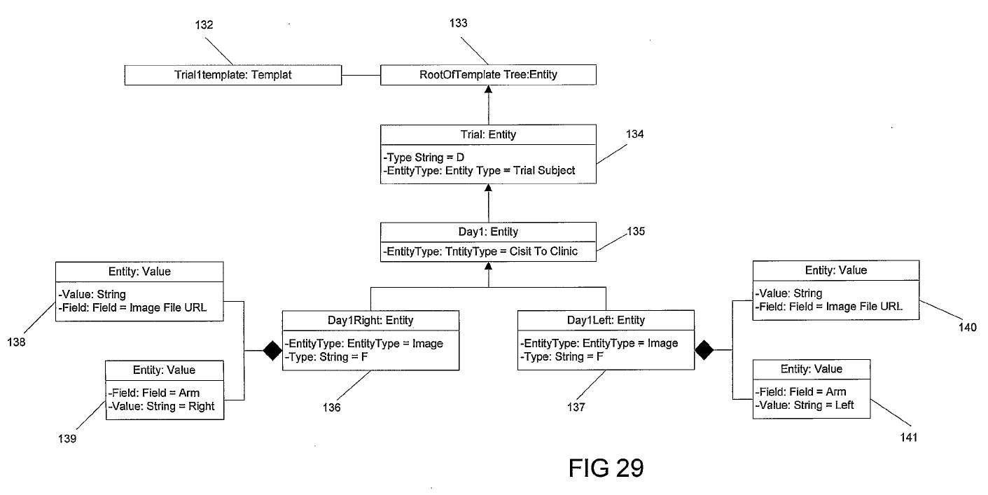

FIG. 29 is an instance diagram for an exemplary embodiment of the present invention;

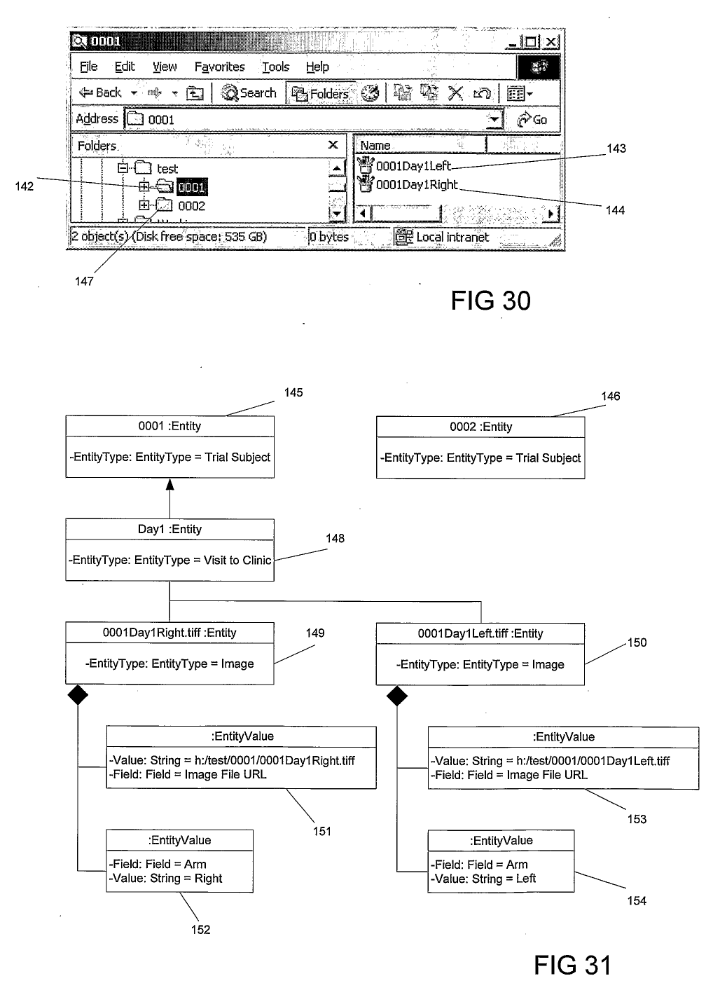

FIG. 30 is a screenshot associated with the exemplary embodiment of the present invention represented by the instance diagram of FIG. 29; and

FIG. 31 is a further instance diagram related to the instance diagram of FIG. 29.

Referring to FIG. 1 there is schematically illustrated a computer system 1 on which the present invention can be implemented. The computer system comprises Random Access Memory (RAM) 2 which includes program memory 2a and data memory 2b. A central processing unit (CPU) 3 is configured to read and execute instructions stored in the program memory 2a. The computer system further comprises a non-volatile storage device in the form of a hard disk drive 4, and an I/O interface 5. The I/O interface 5 is configured to control data input to and output from the computer system 1. Specifically data is received by the I/O interface 5 from an input device such as a keyboard 6. Output data is provided to the I/O interface 5 and output to an output device such as a monitor 7. The components outlined above are connected together by means of a communication bus. It will be appreciated that the configuration illustrated in FIG. 1 is exemplarily and can be varied in ways which will be readily apparent to one of ordinary skill in the art.

FIG. 2 schematically illustrates an embodiment of the present invention. It can be seen that data is stored in a database 8 which is managed by a database management system 9 in a conventional manner. A Graphical User Interface (GUI) 10 is provided to control operation of the database management system 9 via an interface 11. In preferred embodiments of the invention, the database management system 9 is Oracle, and the interface 11 provides commands to the database management system 9 in a manner determined by input received from the GUI 10.

In the described embodiment, the database 8 is configured to store data relating to clinical research and more particularly to store images relating to clinical research. FIG. 3 illustrates how entities may be structured within the database. A Studies entity 12 represents all studies for which data is stored in the database. The Studies entity 12 has as children a Drug 1 entity 13 representing baseline images, and an Drug 2 entity 14 representing images relating to the Drug 2 project. In turn the Drug 2 project entity 14 has a Trial 2 entity 15 as a child. The Trial 2 entity represents a clinical trial and has a plurality of children each of which is an individual subject within a clinical trial. A Person 1 entity 16 is one of those children.

The clinical trial for which data is illustrated in FIG. 4 relates to wound healing. Specifically, a subject is wounded, and response to wounding is measured at a plurality of predetermined time points after wounding. In order to perform this measurement an image is taken at each time point. That is, in the illustration of FIG. 3, the Person 1 entity 16 has as child entities an entity 17 representing zero days after wounding, an entity 18 representing one day after wounding, an entity 19 representing seven days after wounding, an entity 20 representing eight days after wounding, an entity 21 representing ten days after wounding and an entity 22 representing seventeen to twenty four days after wounding. The entity 17 representing zero days after wounding in turn has a child entity 23 representing before wounding, an entity 24 representing five to thirty minutes after wounding, an entity 25 representing one hour after wounding, an entity 26 representing two hours after wounding, an entity 27 representing three hours after wounding and an entity 28 representing four hours after wounding. Each of the child entities of the Person 1 entity 16 stores images taken from the subject at an appropriate time point.

The database 8 is configured to store data in a plurality of suitably arranged tables. An entity relationship diagram for the database 8 is illustrated in FIG. 4. An Entity table 30 is used to store entities represented by stored data.

The entities shown in FIG. 3 are all represented by records of the Entity table 30 of FIG. 4. FIG. 5 illustrates fields of the Entity table. The Entity table 30 contains an ID field which acts as the table's primary key. A Parent_ID field is used to represent hierarchical relationships between entities, such as those illustrated in FIG. 3. For example, the SRN004 entity 16 is represented by a record of the Entity table 30 which has its Parent_ID field set to the ID of a record of the Entity table 30 representing the Trial 1 entity 15. The Entity table 30 provides a Name field into which a name for an entity can be entered. An EntityType_ID field allows each entity to be associated with an entity type defined by records of an EntityType table 31 (described below). It can be seen from FIG. 4 that each entity has a single type, but that a plurality of entities may have the same entity type. Referring back to FIG. 5 it can be seen that the Entity table 30 further comprises a DateCreated field storing appropriate date data. A Person_ID field identifies a user who added a record to the database, SampleTracking_ID, Index AmountRemaining field and Unit_ID fields are also provided. A Locked field specifies whether a structure of entities is locked.

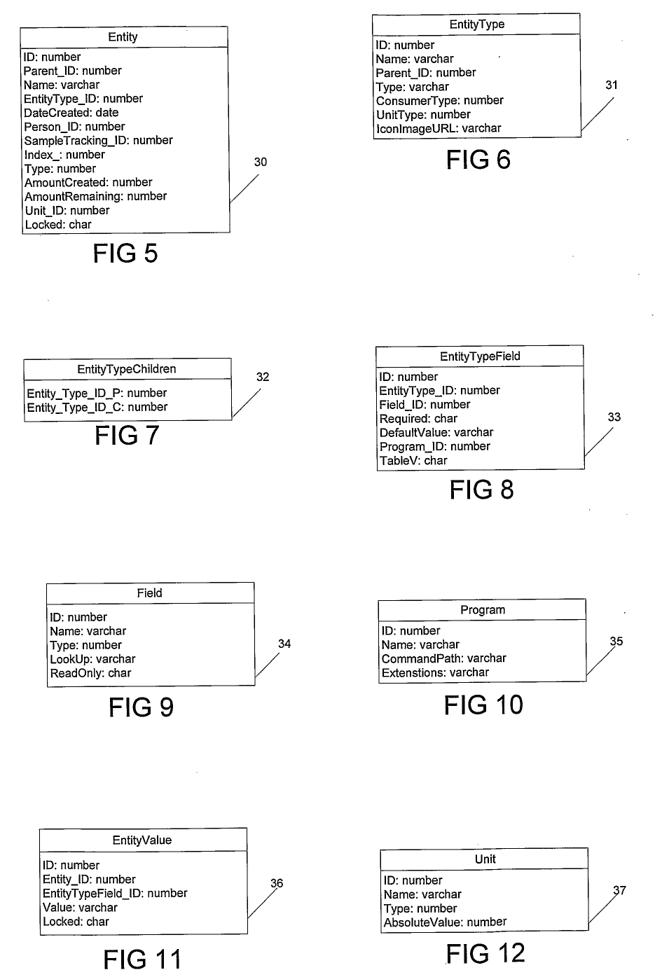

It has been described that entities have an associated entity type, and that entity types are represented by records in the EntityType table 31. Fields of the EntityType table 31 are shown in FIG. 6. It can be seen that the EntityType table has an ID field which acts as its primary key and a Name field which allows naming of different entity types. A ParentID field is used to create hierarchies of entity types. For example, an entity types such as “image” and “clinical image” may be created, and in such circumstances, given that a “clinical image” is an “image”, “clinical image” would have ParentID value pointing to a record of the EntityType table which relate to “image”. A top level entity type has its ParentID set to −1. The EntityType table 31 further comprises a Type field. As described below, the described embodiment of the invention uses template entities. A type field value ‘F’ indicates a template entity associated with a file, while a type field value ‘D’ indicates a template entity associated with a directory. A type field value of ‘U’ denotes a non-template entity. A ConsumerType field a UnitType field are also provided but not used in the described embodiment of the invention. An IconImageURL field is used to specify a path for an image file which provides an icon representing that entity type within a GUI.

Referring back to FIG. 4 it can be seen that relations are defined between the EntityType table 31 and an EntityTypeChildren table 32. The EntityTypeChildren table 32 is shown in further detail in FIG. 7, from which it can be seen that this table comprises Entity_Type_ID_P and Entity_Type_ID_C fields. The Entity_Type_ID_P field identifies a parent entity type, and the Entity_Type_ID_C field identifies a child entity type. This table defines relationships between entity types. For example, an study may comprise experiments, and there is therefore a record in the EntityTypeChildren table which has an study entity identified within its Entity Type_ID_P field and an experiment entity identified within its Entity Type_ID_C field. This table is used to represent the hierarchy of entity types as exemplified by FIG. 3.

Entities defined by the EntityType table 31 are characterised by a plurality of fields, each field being represented by a record of an EntityTypeField table 33. It can be seen from FIG. 4 that each EntityType record may be related to a plurality of EntityTypeField records. FIG. 8 shows fields of the EntityTypeField table 33. It can be seen that an ID field is provided to act as a primary key, and an EntityType_ID field identifies a particular entity type with which a record is associated. A Field_ID field identifies a record in a Field table 34 (described below). A Required field indicates whether a field represented by a record is required or optional. A DefaultValue field provides a value for the field in the absence of specification of a value. A Program_ID field is used to identify a record in a program table 35 (described below). The EntityTypeField table further comprises a TableV field. The TableV field allows configuration of how entities are displayed in a table on a contents panel of a GUI (described below). As well as the entity type, entity name, date created and who created the entity, additional information can be displayed (depending on the entity type). The TableV column contains one of the following for each EntityTypeField ‘M’ mandatory—the values for this will always be displayed in the table, ‘P’ preferred—the values for this field will be displayed unless there are too many ‘mandatory’ fields—but will take preference over ‘optional’ fields, ‘O’ optional—these values will be shown if there are not too many of the above, and ‘N’ never—these will never be shown in the table

As indicated above the EntityTypeField table 33 refers to records of the Field table 34. FIG. 9 illustrates fields of the Field table. An ID field is used to provide a unique identifier for each record of the field table, and each field has a name represented by a Name field. A Type field indicates a type of data stored in each field. Data type is indicated by a two-digit number taking values as follows:

STRING=0
INT=1
DOUBLE=2
CHAR=3
DATE=4
IMAGE=5
TEXT=6
HTML=7
XML=8
PROGRAM_RESULTS=9

The table further comprises a LookUp field storing lookup values used for when a field is a look up field and a ReadOnly field indicating whether or not amendments can be made to a particular record.

As indicated above, the EntityTypeField table also has a relation with the Program table 35, which is shown in FIG. 10. It can be seen that the Program table 35 comprises an ID field, and a Name field. The table further comprises a ComandPath field and an Extensions field. By specifying a record of the Program table 35 representing a particular program in a record of the EntityType table 33, a particular field may be associated with a particular program, thereby allowing that program to be triggered in connection with that field.

It has been described above that an entity is represented by a record of the Entity table 30, and that an entity will have an associated entity type represented by a record of the EntityType table 31. It has also been described that a particular entity type is characterised by its fields, as represented by the EntityTypeField table 33. An EntityValue table 36 stores particular field values for instances of particular entities. This table is illustrated in FIG. 11, where it can be seen that an ID field provides a primary key, and Entity_ID field identifies a record of the Entity table 30 and an EntityTypeField_ID field identifies a record of the EntityTypeField table 33. A Value field stores a field value and a Locked field indicates whether or not the field value is locked.

Referring back to FIG. 4, it can be seen that the Entity table also has a relation with a Unit table 37.

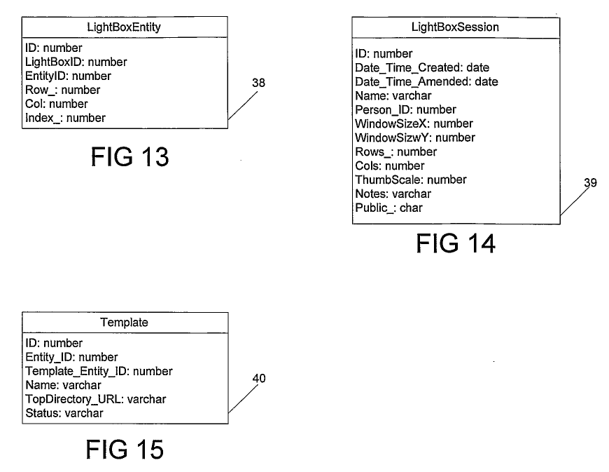

Because the described embodiment of the present invention is concerned with storing data relating to images, various functionality is provided to allow a user to view one or more images, and this is supported by a LightBoxEntity table 38 and a LightBoxSession table 39. The LightBoxEntity table 38 is shown in FIG. 13, and it can be seen that an ID number provides a primary key. A LightBoxID field references a field of the LightBoxSession table 39 (described below) and an EntityID field references a record of the Entity table 30. A light box session comprises a plurality of thumbnail images arranged in a grid, and each image is represented by a record of the LightBoxEntity table 38. Row_ and Col_ fields of the LightBoxEntity table 38 represent the position of a particular light box entity within that grid. An index field is also provided.

As outlined above, LightBoxEntity records are used to define a LightBoxSession, represented by a record of the LightBoxSession table 39, illustrated in FIG. 14. The LightBoxSession table comprises a Date_Time_Created field and a Date_Time_Amended field both storing appropriate date and time data. A Name field is used to provide a name for a light box session. A Person_ID field is used to identify a user associated with a LightBoxSession. WindowSizeX and WindowSizeY fields define the size of a window displaying a light box session, and Rows_ and Cols fields are used to specify a number of rows and columns in which images are arranged. A ThumbScale field is used to specify how images are scaled. A Notes field is used to store notes pertaining to a light box session and a Public_ field is used to specify whether or not other users can access the defined light box session.

As will be described below, the present invention uses templates to allow auto population of a database. Specifically templates can be used to provide prototypes for images at a desired location within a hierarchical arrangement of entities such as that shown in FIG. 3, and to associate appropriate metadata with such images. Templates are represented by a Template table 40, which is shown in FIG. 15. It can be seen that an ID number field provides an identifier, and an Entity_ID field identifies an entity with which a template is associated. A Template_Entity_ID field is also provided and is used to identify an entity at the root of the template tree for a particular template. A name field allows a template to be named, and a TopDirectory_URL specifies a base directory for a template, as described below. A Status field provides status data for a template. Specifically the status field indicates whether a trial is still being undertaken such that images will be added or whether a trial is complete such that images need not be searched for.

Referring back to FIG. 4, it can be seen that a ChangeHistory table 41 is provided, as is an ErrorLog table 42. The ChangeHistory table 41 provides audit trail functionality, and the ErrorLog table 42 stores details of errors.

Having described the structure of the database 8 the GUI 10 and interface 11 used in combination with the database 8 are now described. The GUI is implemented using the Java programming language, and provides a multi-window environment for browsing, searching, viewing images, and producing reports, as described below. A particular embodiment of the present invention supports images stored in bitmap (BMP) TIFF and PNG format.

Referring first to FIG. 16, there is illustrated a window 45 which forms part of the GUI 10. The window 45 comprises three panes. A first pane 46 comprises an explorer tab 47 and a search tab 48, the explorer tab 47 being illustrated in FIG. 16 and showing a hierarchical structure of a plurality of entities of the type described above. The window 45 comprises a second pane 49 which displays information relating to children and contents of an entity selected in the explorer tab 47 of the first pane 46. In the illustration of FIG. 16 it can be seen that the second pane 49 is displaying details of the children of a Studies entity 50 shown in the first pane 46. A third pane 51 displays information relating to the entity currently selected in the second pane 49. If there is an image file associated with the selected entity, this image is displayed. If there is a text file associated with the selected entity that text is displayed. In some circumstances an entity may be associated with data which cannot be readily displayed (e.g. data stored in a proprietary file format such as Microsoft™ Excel™). In such a case a HTML link is provided within the third area 51 and this link is used to launch an appropriate program to allow the associated data to be viewed.

FIG. 17 illustrates a window 52 which is part of the GUI 10 and which allows configuration of entity types, the associated data being stored in appropriate tables of FIG. 4. The window 52 is caused to be displayed by selecting an image entity in the area 51, and selecting a configure type option from a menu shown in FIG. 17a. The window 52 is used to create new entity types, and also to modify data associated with existing entity types. Each entity type is represented by a record in the EntityType table 31 (FIG. 4), and data input and edited using the window 52 is used to edit the appropriate record of that table. It can be seen that the window 52 includes a user-editable text box 53 which contains a name for the entity type being configured. A further text box 54 is provided to enter a path name of a file which provides an icon for the entity type. The text box 54 is accompanied by a browse button 55, selection of which displays a file explorer window allowing an appropriate icon file to be located, and its path to be inserted into the text box 54. A consumer type can be selected from appropriate drop down lists 56, 57.

The Window 52 further comprises an area 58 in which details of the currently edited entity's parent entity are displayed. The area 58 displays all data associated with the parent entity allowing a user to observe data that will be inherited.

As has been described above, entities are used to build up a hierarchical structure of experimental data. Entities within that hierarchical structure may comprise different entity types, and an area 59 is used to specify which entity types may be added the currently edited entity type. The area 59 comprises a list 60 displaying all currently defined entity types. It can be seen that an “Image” entity 61 in the list 60 is displayed together with a “+” symbol indicating that this entity has associated subtypes, the use of which is described below. Items of the list 60 are selectable by a user and a button 62 is selectable to cause the selected item to be moved from the list 60 to an area 63 to indicate that these entities can be added to the currently edited entity type. Items can be removed from the area 63 (and returned to the list 60) by selecting items in the area 63 and using a button 64. In the illustrated example, it can be seen that no types can be added to an Image entity. That is, every Image entity is a leaf in a hierarchy of entities. Hierarchical relationships between entity types specified using the area 59 of the window 52 are represented by records of the EntityTypeChildren table 32 (FIG. 4) in the manner described above.

An area 65 of the window 52 is used to specify sub-types for the currently edited entity type. It can be seen in the illustration that the edited entity type “Image” has as sub-types “Macroscopic” images, “Clinical image” and “Microscopic” images. The presence of “+” symbols alongside the “Macroscopic” and “Clinical images” entities indicates that these types in turn have sub-types of their own. A sub-type may be selected and a “Remove” button 66 may then be selected to cause the sub-type to be deleted. A “New” button 67 is selectable to add a further sub-type to the currently edited entity type, this results in creation of a new record in the EntityType table 31 (FIGS. 4 and 6) and this record is initially created so as to be identical to its parent.

An “Edit” button 68 is operable to display a further window 52 populated with data relating to the selected sub-type for editing. Thus, the “New” button 67 can be used to create a new sub-type which will be generated as an identical child of its parent, and the “Edit” button 68 can then be used to edit details of that child. The concept of sub-types and inheritance as used here is that used in many object-orientated computer systems, including for example Java®. Inheritance of this type is represented in the described embodiment of the present invention by use of the ParentID field of the EntityType table 31 (FIG. 4).

As described above, entities have a plurality of fields, and an area 69 of the window 52 is used to specify details of such fields. Referring back to FIG. 4, it will be recalled that fields are defined by records of the Field table 34, and associated with a particular entity type (represented by a record of the EntityType table 31) by a record of the EntityTypeField table 33. All fields currently defined in the Field table 34 are displayed in a list 70. A field can be selected in the list 70 and a button 71 can be used to associate the field with the currently edited entity type, causing details of the field to be displayed in an area 72, and an appropriate record to be created in the EntityTypeField table 33 associating the field and the entity type. Fields displayed in the area 72 are represented by a field name 73, and a tick box 74 can be used to indicate whether a value for that field is required. A text box 75 is used to specify a default value for the field, and a text box 76 is used to indicate whether or not the field value should be displayed in the pane 51 of the window 45 (FIG. 16) when an instance of that entity type is selected. A text box 77 (partially shown in FIG. 16) is also provided, and this provides details of a program associated with a field if appropriate (described below). It will be appreciated that data entered in the area 72 is stored within the appropriate record of the EntityTypeField table 33.

A field within the area 72 can be selected and a button 78 can be used to remove the field from the area 72, and to delete the corresponding record from the EntityTypeField table 33. As indicated above, the fields displayed in the area 70 are all represented by records of the Field table 34. Any field selected in the area 70 can be amended by selecting a field and using an “Amend Field” button 79. Similarly, new fields can be created by using a “New Field” button 80. If the button 79 or the button 80 are selected, a window 81 shown in FIG. 18 is displayed. If the button 79 is selected the window 81 is displayed with data relating to the field to be amended, while if the button 80 is selected a blank version of the window 81 is displayed.

Referring to FIG. 18, it can be seen that a text box 82 is provided to allow a field name to be specified, and a data type for the field is selectable using a drop down list 83. In one embodiment of the invention vales for the drop down list are hard coded in the program code. A tick-box 84 is selectable to indicate that a field value can not be altered. An area 85 is used to specify details relevant to look-up fields. A pair of radio buttons 86 indicate whether or not the field is a look-up field, and a list 87 specifies values which are used for the look-up. The entries in the list 87 are taken from the LookUp field of the Field table 34. Having completed editing of a field an apply button 88 is selectable to accept changes, and a cancel button 89 is selectable to cancel changes.

Referring back to FIG. 17, it can be seen that the window 52 provides two further buttons: a “New Program” button 90 and an “Amend Program” button 91. These buttons can be used to configure which program (represented by an entry in the Program table 35 of FIG. 4) is associated with a particular entity type. Specifically, if a field has a type of Program Results Link, the corresponding record of the EntityTypeField table will refer to a program in the Program table 35, and details of this program can be specified or amended by using the buttons 90 and 91.

FIG. 18a illustrates a window 92 used to specify features of a program. The window 92 comprises a text box 93 configured to store a name for a program and a textbox 93a which is used to input file extensions associated with the program. A textbox 94 is populated by using a browse button 94a to display a file explorer window, and store a location at which the program is stored. The window 92 is displayed by selection of the buttons 90 and 91 of the window 52 shown in FIG. 17.

It has been mentioned above that entities can be template entities which are used to automatically populate a hierarchy of entities. In general terms such templates are used to locate appropriate image files stored within a file system and create appropriate entities for the storage of such images, and in some cases generate appropriate metadata to be stored alongside the images. Thus, having created an appropriate hierarchy of entity types (as described above), suitable templates comprising a hierarchically arranged collection of template entities can be created. These templates are a hierarchically arranged collection of template entities of particular entity types which act as prototypes for entities representing data. Creation of such templates is now described with reference to a window 95 illustrated in FIG. 19 which forms part of the GUI 10. The window 95 is displayed by selecting a template option on a dropdown menu of the form shown in FIG. 17a.

Referring to FIG. 19, it can be seen that the window 95 allows a name to specified for the template in a text box 96, and a path name of a directory to be specified in a text box 97. The path name can be generated by selecting a browse button 98 which results in display of a file explorer window. A directory can then be selected from that file explorer window, and its path is entered into the text box 97. The specified path name is that of a directory that will be used as a root directory in searching for images. This information is stored within an appropriate record of the Template table 40 (FIG. 4).

The window 95 provides a pane 99 in which a hierarchy of entities can be created, relative to a root template entity 100. From the pane 99 a user may right click on the displayed root template entity 100 to cause a menu 101 to be displayed which is operable to create a structure of entities which will store data. It can be seen that the menu 101 includes an “Add” option which can be used to add an entity-type to the hierarchy, suitable entity types being listed by a sub-menu 102, and being determined by the hierarchical relationships specified between entity types as described above. In the illustrated embodiment it can be seen that the sub-menu includes a single “Group” entity, given that this is the only template entity which can be added to the root entity.

The menu 101 further provides options to edit a particular template entity (described below), and to rename or remove a particular template entity. Cut, copy and paste options are also provided which allow “cut-and-paste” functions to be used.

The ‘UP’ and ‘DOWN’ options of the menu 101 will change a position of a child relative to other children within the hierarchy. Selection of a ‘history’ item within the menu 101 displays a window showing an audit trail of changes made to a particular entity. This window is illustrated in FIG. 19a.

The preceding description has been concerned with creation of a template from appropriate entity types by specifying suitable relationships, which is facilitated by selecting a first radio button 103 from a pair of radio buttons 103, 104. However, if the radio button 104 is selected, a template can be created based upon an existing template, selected from a list of existing templates 105, thereby reducing the time taken to create new templates. The templates displayed in the list 105 are read from the Template table of the database.

Creation and editing of a template entity is now described with reference to FIGS. 20 and 21. Referring first to FIG. 20, a dialog 106 used to specify and edit details of a template entity is shown. This is displayed in response to selection of “Edit” from the menu 101 of FIG. 20. The dialog 106 comprises a name text box 107 into which a search string can be entered. When a template is executed, this search string is compared with file and directory names, and files and/or directories matching the search string are added to the database as an instance of that particular entity. The search string can comprise a string of literal characters such as “LG000”. Such a string will match only file names “LG000” with no flexibility. However, a search string may include wildcard characters, such that a search string “LG000*” will match all file names including “LG000” regardless of what other characters may surround this string within the file name. Similarly “*” characters can be used at other positions within a search string. Additionally, characters “[” and “]” have special meaning. Specifically, a range of numbers may be specified between “[” and “]” and a file including any number in that range will match that search string. For example, a search string “*A[0-100]*” will match any file name comprising an “A” character followed by a number in the range zero to one hundred, that is filenames including “A5”, “AA50”, “A56” and “BHHSDA90S.TIFF” will all match the specified search string.

It should be noted that in some cases, template entities do not specify a search string. Such entities are used to specify a hierarchal level, and are not intended to directly stored data. For example, referring back to FIG. 2 the directories associated with particular time points were not directly stored data but will themselves store folders which in turn store data.

A central portion 108 of the dialog 106 is used to specify metadata that will be associated with entities representing file names which match the specified search string. This area is created dynamically according to what fields are specified for the entity type associated with the template entity. The values entered in the displayed fields will be entered into the fields of all entities created by the template. It will be appreciated that some of the fields may be look up fields. For example, in the illustration of FIG. 20, an Image Description field 109 is such a look up field, and as illustrated in FIG. 21 (which shows part of the dialog 106) a menu of options 110 is displayed to the creator of the template entity.

Referring back to FIG. 20, a Type drop down list 111 is provided which allows specification of whether the template entity will be matched by files, directories, or in come cases neither. It is appropriate that a template entity should match neither files nor directories for entities where they are not to hold images, but simply to preserve experimental structure.

From the preceding description, it will be appreciated that a template representing a hierarchical structure can be created, and template entities can be associated with entity types within that structure, the template entities being operable to create entities representing located images, and to create appropriate metadata for those images. The use of such templates is now described with reference to the flowchart of FIG. 22.

Object-oriented computer program code is written to implement the steps depicted by the following flowcharts.

Referring to FIG. 22, at step S1 a connection with the database 8 is established. At step S2, all templates represented by a record of the Template table 40 having a status of “Active” are retrieved, and these retrieved templates are then processed in turn. At step S3 a check is made to determine whether or not there are more templates to process. If no further templates exist, the database connection is closed at step S4 and processing ends. If a further template exists its information is retrieved at step S5, and the directory specified by the template is processed at step S6, as illustrated by the flowchart of FIG. 23.

Referring to FIG. 23, at step S7 a check is made to ensure that the specified directory exists within the file system. If the directory does not exist, processing ends at step S8. Assuming that the directory does exist, processing passes to step S9 where a list of files and sub-directories present within the directory is obtained. At steps S10 to S12, suitable sorting of directory contents is carried out. At step S10 a check is made to determine whether the directory contains files or sub-directories. Sub-directories are sorted alphanumerically at step S11 and files are sorted by date at step S12.

Each file or sub-directory is then processed in turn. At step S13 a check is made to determine whether or not there are more files or sub-directories to be processed. If there are no more files or directories to be processed, processing ends at step S14. If however more files or directories exist which are to be processed, at step S15 an appropriate template entity within the hierarchy specified by the template is located. This locating is carried out by comparing the located file or directory with the name of each template entity, which, as described above acts as a search string. If no appropriate template entity is found (step S16), the file is not processed, and processing returns to step S13. If however an appropriate template entity is found at step S16, processing continues at step S17 where an entity representing the template entity is created. It will be appreciated that creation of the entity will require creation of a new record in the Entity table 30. This new record is populated with an ID which acts as an identifier. Values for the Name, and EntityType_ID fields are derived from the matched template entity. A value for DateCreated can be automatically set (step S18). Additionally, linked records in the EntityValue table 36 may need to be created to represent the created entity's field values. These can be populated with data as specified by the template entity, in the manner described above.

At step S19, a check is made to determine whether the located file system object is a file. If it is a file, a check is made at step S20 to determine whether or not the file is an image file (i.e. a file having a file type recognised by the system as an image file type). If the file is an image file, the file's name is entered into an appropriate record of the EnityValue table 36 at step S21, and processing then passes to step S22. If the located file system object is not an image file, processing passes directly to step S22

At step S22 the hierarchical path of the created entity back to the root of the template is calculated by using the ParentID field of the Entity table. It will be appreciated that entities may need to be created at intervening levels within the hierarchy and this is done at step S23. At step S24 a check is made to ensure that the processing of step S23 was completed successfully. If the processing was not successful, processing returns to step S13, otherwise processing continues at step S25, where a check is made to determine whether a directory has been located. If the located object is not a directory, processing again returns to step S13. If however the located file system object is a directory, the directory's contents are processed at step S26, in the manner described above for the current directory.

FIG. 24 illustrates the processing of step 15, which locates an appropriate template entity for a given file system object in further detail. At step S27 all template entities present within the currently processed template are retrieved. Template entities associated with the currently processed template are located using the template_entity_id field as described above. At step S28 a check is made to determine whether the template is configured to match files (as opposed to directories) and the currently processed object is a file. At step S29 a similar check is made to determine whether the template is configured to match directories and the currently processed object is a directory. If either of these checks is successful, processing passes to step S30 where the search string associated with the template entity is compared with the name of the currently processed file system object. Step S31 checks for a match. If a match is detected, the located template entity is returned at step S32 and processing terminates.

If step S28 and step S29 find no type match, processing passes to step S33, where, if the template is associated with neither files nor directories, a check is made to determine whether the currently processed file system object has a name matching the search string of the template entity. If there is a match, processing again passes to step S32 where the located template entity is returned.

If no match is found at step S33, it can be determined that the currently processed template entity does not match the currently processed file system object. At step S34, a check is made to determine whether or not there are more template entities to be processed. If no more template entities are found, a value of NULL is returned at step S35. If however further template entities exist, the processing of FIG. 24 is applied to one of those template entities at step S36. At step S37 a check is made to determine whether the processing of step S36 returned NULL. If NULL is returned, processing returns to step S34. If however a template entity is returned, processing passes to step S38 where the located template entity is returned.

Referring now to FIG. 25, the processing of step S23 of FIG. 23 is shown in further detail. It will be recalled that step S23 is concerned with ensuring that the necessary structure of entities at higher hierarchical levels exists. At step S39, all existing entities are retrieved from the database. At step S40 the hierarchy of entities required to support the processed entity is determined, and one of these entities is selected for processing. At step S41 a check is made to determine whether or not an entity corresponding to the required template entity exists. If an appropriate entity is found, this entity is related to the currently processed entity at step S42, otherwise an appropriate entity is generated at step S43.

At step S44 the structure of this created or used entity is checked against the hierarchy as described above, and processing continues, until the hierarchy necessary to support the entity representing the processed file has been created, and an appropriate entity is returned at step S45.

Having described the processing carried in the embodiment of the present invention with reference to the flowcharts of FIGS. 22 to 25, Java classes used to implement the present invention are now described with reference to FIGS. 26 to 31.

Referring first to FIG. 26, a Unified Modelling Language (UML) diagram of classes which are key to an implementation of the present invention is illustrated. It can be seen that four hierarchically arranged classes are illustrated. An ImageBase.Wrapper class 120 is a superclass for three classes. Namely, an ImageBase.EntityValue class 121, an ImageBase.Entity class 122 and an ImageBase.Template class 123. The use of these classes is described in further detail below, although it should be noted that an object created by instantiation of the ImageBase.Entity class 122 is composed of a plurality of objects which are in instantiations of the ImageBase.EntityValue class 121. It should also be noted that each ImageBase.Entity object can have a plurality of relationships with other ImageBase.Entity objects, thereby providing a hierarchy. It should further be noted that objects of the ImageBase.Entity class 122 has a one to one relationship with objects of the ImageBase.Template class 123. A template object has two one-to-one relationships with objects of the entity class—one is the root template class, the other the entity which the template represents.

Referring now to FIG. 27, a DirectorySearcher object 124 is illustrated. The Directory Searcher object contains a main( ) method which triggers population of database tables using templates as described above. In this regard, it can be seen that a Directory Searcher object has a relationship with an ImageBase.Template object 123a, being an instantiation of the ImageBase.Template class 123. Each DirectorySearcher object has a relationship with a plurality of ImageBase.Template objects FIG. 27 shows relationships between the ImageBase.Template object 123a, an ImageBase.Entity object 122a, and an ImageBase.EntityValue object 121a, being instantiation of the appropriately named classes described above.

FIG. 27 also illustrates a further ImageBase.Entity object 122b which represents a particular entity instantiated by the ImageBase.Template object 123. The ImageBase.Entity object has a relationship with an ImageBase.EntityValue object 121b. It should be noted that an ImageBase.Entity object 122a identifies an entity associated with the template of the ImageBase.Template object 123a. In contrast, the ImageBase.Entity object 122b represents entities which are instantiated by operation of a respective template represented by the ImageBase.Template object 123a, as is now described in further detail with reference to FIG. 28.

FIG. 28 is a sequence diagram showing operation of the invention in a situation in which a single template has been configured. The configured template has an associated entity named TrialEntity and has a root template entity named RootTemplate.

Referring to FIG. 28, a main( ) method associated with the DirectorySearcher object 124 is called. This causes each template to be processed in turn, although it should be noted that in the case of the illustrated embodiment only single template exists. Thus, the main( ) method of the DirectorySearcher object 124 calls a readDirectory( ) method associated with a Template object 127. This in turn causes the readDirectory( ) method to be called on a TrialEntity object 128, TrialEntity being the entity associated with the directory which is to be processed. The calling of the readDirectory( ) method on the TrialEntity object 128 in turn calls a getBestTemplateEntityFor( ) method on the RootTemplate object 129 to process a file located within the read directory. Given that the file does not satisfy the criteria for instantiation of the RootTemplate object 129, a getBestTemplateEntityFor( ) method is called on its Child entity 130. Having reached the bottom of the hierarchy, an identifier of the Child entity 130 is returned to the RootTemplate object 129 which in turn passes this reference back to the TrialEntity object 128. At this stage, it can be determined that the Child entity 130 is the entity to be instantiated to represent the processed file. Accordingly, the TrialEntity object 128 calls a copy( ) method on the Child entity 130. The Child entity 130 then calls a create( ) method to generate a copy of the child entity 131. The TrialEntity object 128 also sets the name of the created entity 131 as well as using a setValue method provided by that object to provide details of the name of the located image, and a getRootTo method to generate hierarchical data. Each of these methods results in data being returned from the Child entity object 131 to the TrialEntity 128. When this is done, processing returns to the DirectorySearcher 124 via the Template 127.

In general terms, it should be noted that the getBestTemplateFor method is called recursively on each entity within a template entity in turn, until a match is found, or there are no more template entities to process.

Having described how Java classes interact to implement an embodiment of the present invention, objects created in an exemplary embodiment are now described. FIG. 29 is an instance diagram showing objects created in the exemplary embodiment of the invention. It can be seen that a Trial1template object 132 has a relationship with a RootOfTemplateTree object 133. The RootOfTemplateTree object 133 is the object associated with the Trial1template 132. The RootOfTemplateTree object has a Trial entity 134 as its child, and the Trial entity 134 in turn has a Day1 entity 135 as its child. The Day1 entity 135 has two child entities, a Day1Right entity 136 and a Day1Left entity 137. It can be seen that the Day1Right entity 136 has two associated entity values 138, 139, while the Day1Left entity has two associated entity values 140, 141.

FIG. 30 is part of a directory structure which CAN be processed using the object illustrated in FIG. 29. Specifically, a directory “0001” 142 contains two image files. A first image file “0001Day1Left” 143 and a second image file “0001Day1Right 144”. The rules associated with the Day1Right entity 136 and the Day1Left entity 137 are such that as a matter of routine, the 0001Day1Left image 143 would be associated with the Day1Left entity 137 while the 0001Day1Right file 144 would be associated with the Day1Right entity 136.

FIG. 31 is a further instance diagram which relates to that which is shown in FIG. 30. It can be seen that a first object 0001 145 represents the directory “0001” 142 (FIG. 30). Similarly, an object 0002 146 represents the directory “0002” 147. It can be seen that operation of the templates of the type described above causes a Day1 entity object 148 to be instantiated, with objects 149, 150 being instantiated to respectively represent the files 143, 144. Each of the objects 149, 150 have associated EntityValue objects. EntityValue objects 151, 152 are associated with the object 149, while EntityValue objects 153, 154 are associated with the object 150.

It will be appreciated that although preferred embodiments of the present invention have been described above, various modifications can be made to these embodiments without departing from the spirit and scope of the present invention, as defined by the appended claims.

1: A method for storing data in a database using configuration data specifying an entity and a condition associated with the entity, the method comprising:
processing a plurality of data items, said processing including determining for each data item whether said condition is satisfied by one of said plurality of data items; and
if said condition is satisfied by one of said plurality of data items, creating an instance of said entity, said entity being associated with said one data item.

2: A method according to claim 1, wherein:
said configuration data specifies a plurality of entities, and each of said plurality of entities has an associated condition;
said processing comprises determining for each data item whether a condition associated with one of said plurality of entities is satisfied by the respective data item; and
if one of said conditions is satisfied, creating an instance of the entity associated with the satisfied condition, said entity being associated with the respective data item.

3: A method according to claim 1, wherein said processing comprises processing a plurality of items arranged within a predetermined location in a data repository, and each of said data items has an associated identifier.

4: A method according to claim 3, wherein said condition associated with the or each entity comprises a text string, and said condition is satisfied by a data item having an identifier having a predetermined relationship with said text string.

5: A method according to claim 4, wherein said predetermined relationship is defined to be a predetermined degree of matching between said identifier and said text string.

6: A method according to claim 5, wherein said text string includes at least one wildcard character, said wildcard character being configured to match any character of said identifier.

7: A method according to claim 5, wherein said text string includes at least one multi-character wildcard character, said multi-character wildcard character being configured to match any zero or more characters of said identifier.

8: A method according to claim 1, further comprising storing said data item within said created entity.

9: A method according to claim 1, further comprising storing a reference to said data item within said created entity.

10: A method according to claim 1, wherein said plurality of data items are a plurality of files.

11: A method according to claim 10, wherein said plurality of files are stored within a predetermined directory of a file system.

12: A method according to claim 11, wherein said predetermined directory comprises at least one sub-directory, and said sub-directory contains at least some of said plurality of files.

13: A method according to claim 12, further comprising:
processing items stored in said predetermined directory; and
for each processed item, determining whether said item is a sub-directory or a file;
wherein said condition is based upon said determination.

14: A method according to 10, further comprising:
processing said plurality of files; and
determining a file type associated with each of said plurality of files;
wherein said condition specifies a predetermined file type.

15: A method according to claim 1, further comprising:
generating metadata associated with said one data item; and
storing said metadata within said instance of said entity.

16: A method according to claim 15, wherein generating said metadata comprises generating said metadata based upon said one data item.

17: A method according to claim 16, wherein said one data item is a file, and generating said metadata comprises generating said metadata based upon a name of said file.

18: A method according to claim 16, wherein said one data item is a file, and generating said metadata comprises generating metadata based upon a file type of said file.

19: A method according to claim 16, wherein said metadata is based upon a location of said file within a file system directory structure.

20: A method according to claim 1, wherein said data item is an image.

21: A method according to claim 1, wherein said configuration data defines at least one relationship involving the or each entity.

22: A method according to claim 21, wherein said relationship defines a hierarchy of entities.

23: A method according to claim 22, wherein creating an instance of an entity comprises;
determining existence of an appropriate instance of an entity at a higher hierarchical level; and
creating said instance of an entity at a higher hierarchical level if said determining determines that said no instance of said entity exists.

24: A method according to claim 1, further comprising:
receiving user input defining said configuration data.

25: A method according to claim 1, wherein said configuration data specifies a relationship involving the said at least one entity.

26: A method according to claim 25, wherein said configuration data specifies an inheritance relationship involving the said at least one entity.

27: A method according to claim 1, wherein said configuration data specifies a plurality of fields associated with said entity which are to be populated upon creation on said entity.

28: A method according to claim 27, wherein said configuration data further specifies values for at least some of said plurality of fields.

29: A method according to claim 28, wherein said specified values for at least some of said plurality of fields are defined with reference to said data item.

30: A method according to claim 1, further comprising storing data indicating a computer program, said computer program being executable to cause manipulation or display of data associated with said entity.

31: A computer readable medium carrying computer readable program code configured to cause a computer to carry out a method according to claim 1.

32: A computer apparatus for storing data in a database, the computer apparatus comprising:
a program memory containing processor readable instructions; and
a processor configured to read and execute instructions stored in said program memory;
wherein said processor readable instructions comprises instructions configured to control the processor to carry out a method according to claim 1.

33: An apparatus for storing data in a database, the apparatus comprising:
storage means storing configuration data specifying an entity and a condition associated with said entity;
a processor configured to process a plurality of data items, said processor being configured to determine for each data item whether said condition is satisfied by one of said plurality of data items; and
creation means configured to, if said condition is satisfied by one of said plurality of data items, create an instance of said entity, said entity associated with said one data item.

34: Apparatus according to claim 33, wherein:
said configuration data specifies a plurality of entities, and each of said plurality of entities has an associated condition;
said processor is configured to determine for each data item whether a condition associated with one of said plurality of entities is satisfied by the respective data item; and
said creation means is configured to, if one of said conditions is satisfied, create an instance of the entity associated with the satisfied condition, said entity being associated with the respective data item.

35: Apparatus according to claim 33, further comprising:
a data repository storing said plurality of data items, each data item having an associated identifier.
wherein said processor is configured to process a plurality of data items arranged within a predetermined location in a data repository.

36: Apparatus according to claim 33, wherein said creation means is configured to store said data item within said created entity.

37: Apparatus according to 33, wherein said creation means is configured to store a reference to said data item within said created entity.

38: Apparatus according to claim 33, wherein said plurality of data items are a plurality of files.

39: Apparatus according to claim 38, further comprising a file system defining a plurality of directories, wherein said plurality of files are stored within a predetermined directory of said file system.

40: Apparatus according to claim 39, wherein said predetermined directory comprises at least one sub-directory, and said sub-directory contains at least some of said plurality of files.

41: Apparatus according to claim 33, wherein:
said processor is configured to generate metadata associated with said one data item; and
said creation means is configured to store said metadata within said instance of said entity.

42: Apparatus according to claim 33, wherein said data item is an image.

43: Apparatus according to claim 33, wherein said configuration data defines at least one relationship involving the or each entity.

44: Apparatus according to claim 43, wherein said relationship defines a hierarchy of entities.

45: Apparatus according to claim 44, wherein said creation means is further configured to:
determine existence of an appropriate instance of an entity at a higher hierarchical level; and
create said instance of an entity at a higher hierarchical level if said determining determines that said no instance of said entity exists.

46: Apparatus according to claim 33, further comprising:
user input means configured to receive configuration data.

47: Apparatus according to claim 33, wherein said configuration data specifies a relationship involving the said at least one entity.

48: Apparatus according to claim 47, wherein said configuration data specifies an inheritance relationship involving the said at least one entity.

49: Apparatus according to claim 33 wherein said configuration data specifies a plurality of fields associated with said entity which are to be populated upon creation on said entity.

50: Apparatus according to claim 49, wherein said configuration data further specifies values for at least some of said plurality of fields.

51: Apparatus according to claim 50, wherein said specified values for at least some of said plurality of fields are defined with reference to said data item.

52: A method for storing data in a database the method comprising:
determining an entity to be instantiated to store said data;
processing data defining at least one relationship between said entity and at least one further entity;
determining existence of an appropriate instance of said at least one further entity; and
creating said instance of said at least one further entity if said determining determines that said no appropriate instance of said at least one entity exists.

53: A method according to claim 52, wherein determining an entity to be instantiated further comprises
processing configuration data specifying a plurality of entities and a condition associated with each entity,
processing a data item, said processing including determining if a condition satisfied by said data item; and
creating an instance of the entity associated with said satisfied condition.

54: A method according to claim 52, further comprising:
creating an instance of said entity to be instantiated to store said data.

55: A method according to claim 54, further comprising:
generating metadata relating to said data; and
storing said metadata.

56: A method according to claim 55, wherein said metadata is based upon said data.

57: A computer readable medium carrying computer readable program code configured to cause a computer to carry out a method according to claim 53.

58: A computer apparatus for storing data, the computer apparatus comprising:
a program memory containing processor readable instructions; and
a processor configured to read and execute instructions stored in said program memory;
wherein said processor readable instructions comprises instructions configured to control the processor to carry out a method according to claim 53.

59: A computer system for storing data in a database, comprising a processor configured to:
determine an entity to be instantiated to store said data;
process data specifying at least one relationship between said entity and at least one further entity;
determine existence of an appropriate instance of said at least one further entity; and
create said instance of said at least one further entity if said determining determines that said no appropriate instance of said at least one entity exists.

60: A method for storing data in a database using configuration data specifying a plurality of entities and conditions associated with each of entities, the method comprising:
processing a data item, said processing including determining for said data item whether one of said conditions is satisfied; and,
if said condition is satisfied, creating an instance of the respective entity, said entity being associated with said one data item, processing data defining at least one relationship between said created entity and at least one further entity, determining existence of an appropriate instance of said at least one further entity, and creating said instance of said at least one further entity if said determining determines that said no appropriate instance of said at least one entity exists.
